(19) United States
(12) Patent Application Publication
(10) Pub. No.: US 2008/0037820 A1
(43) Pub. Date: Feb. 14, 2008

(54) Sound Generating Apparatus

(76) Inventor: Keiji Koga, Osaka (JP)

Correspondence Address: BIRCH STEWART KOLASCH & BIRCH, PO BOX 747, FALLS CHURCH, VA, 22040-0747, US

(21) Appl. No.: 11/791,522

(22) PCT Filed: Nov. 24, 2005
(86) PCT No.: PCT/JP05/22031

§ 371 Date: May 24, 2007

(30) Foreign Application Priority Data
Nov. 26, 2004 (JP) 2004-342736

(51) Int. Cl. H04R 1/00

(52) U.S. Cl. 381/419

(57) ABSTRACT

An object of the invention is to provide a sound generating apparatus which reproduces sound, such as music or voice, from a sound generating member, such as a flower or a tree. A sound generating apparatus 10 includes a vibration unit 11 and a drive unit 14. The vibration unit 11 includes a vibration member 12 to be attached to a sound generating member 1 and a solenoid coil 13 wound around the vibration member 12. The drive unit 14 includes a magnet 15 and a bottom part 17b, a trunk part 17a, and a top part 17c. The magnet 15 is provided at one end with respect to the axial direction of the core member, and opposes one lateral face of the solenoid coil. The bottom part 17b is provided so as to oppose the vibration member 12 with interposing the magnet 15 between the bottom part 17b and the vibration member 12, the trunk part 17a is in the form of a cylinder, extending from the outer part of the bottom part 17b so that the trunk part 17a covers the outer peripheries of the vibration unit 11 and the magnet 15. The top part 17c extends from an end of the trunk part 17a in the direction of the diameter so as to oppose the second lateral face of the solenoid coil 13.

### FIELD OF THE INVENTION

The present invention relates to a sound generating apparatus, more specifically, a sound generating apparatus for generating sound such as music and voice from a sound generating member, e.g. a flower, plant or tree, which is rigid sufficient to transfer vibrations.

### BACKGROUND ART

FIG. 10 is a diagram for explaining an existing sound generating apparatus 100.

The sound generating apparatus 100 is provided with a coil unit 110 and a magnetic unit 120. The coil unit 110 includes a cylindrical magnetic core 111 and a solenoid coil wound around the outer periphery of the magnetic core 111. The magnetic core 111 has an insertion opening 113 for inserting a sound generating member e.g. a flower, plant or tree, which is rigid sufficiently to transfer vibrations. This structure will permit a sound as music and voice is generated from the sound generating member.

The magnetic unit 120 is in the form of a disk having a predetermined thickness. The magnetic unit 120 includes a magnet 121, an upper yoke 123, and a lower yoke 125. The magnet 121 has an insertion opening 122 at the center thereof, for inserting the coil unit 110 therein. Accordingly, the coil unit 110 is installed coaxially with the magnetic unit 120. The upper yoke 123 is in the form of a disk having an outer diameter smaller than that of the magnet 121, and is configured to extend along the upper surface of the magnet 121. The upper yoke 123 has an opening at the center thereof, having a diameter equal to that of the insertion opening 122. Further, the lower yoke 125 is in the form of a disk having an outer diameter that is equal to the outer diameter of the upper yoke 123. The lower yoke 125 is configured to extend along the lower surface of the magnet 121, and has an opening at the center thereof, having an inner diameter that is equal to the insertion opening 123.

Magnetic flux lines are generated by the magnet 121 in the sound generating apparatus 100. When generated, the flux lines extend from the upper surface of the magnet 121 (North Pole) to the upper yoke 123, and extend in an upper direction, with respect to the apparatus. Then, the magnetic flux lines encircle the outer peripheries of the upper yoke 123, magnet 121, and lower yoke 125 and return to the magnet 121 from the lower surface thereof. In addition to the above, magnetic flux lines closest to the coil unit run at the center, with respect to the diameters of the upper yoke 123, magnet 121, and lower yoke 125 and return to the magnet 121 from the lower surface thereof, via the lower yoke 125.

On the other hand, circular magnetic flux lines are generated around the solenoid coil 112, when ends of the solenoid coil 112 are connected to the output terminals (not shown) of a sonic apparatus, and electrical signals such as music are input from the sonic apparatus. Here, the circular magnetic flux lines are formed across the winding direction of the solenoid coil 112.

The magnetic flux lines from the magnet 121 and the solenoid coil 112 affect on each other. Then, an electromagnetic force is generated, which makes the magnetic core 111 move in the diameter directions of the magnetic core 111, and the coil unit 110 vibrates. The thus obtained vibration is transferred to the sound generating member, such as a plant or a flower, which is inserted in the insertion opening 113 of the magnetic core 111. Then, sound is produced from the sound generating member (for example, refer to Japanese Kokai Publication 2003-333677).

### DISCLOSURE OF THE INVENTION

### Problems to be Solved by the Invention

When the above-mentioned sound generating apparatus 100 is used, magnetic flux lines are generated in a diameter direction of the magnetic unit 120, as shown in FIG. 10. Accordingly, it is not possible to make all the magnetic flux lines generated by the magnet 121 pass through the magnetic core 111. This means that all the magnetic force from the magnet 121 is not efficiently used, and magnetic force has to be wasted. Moreover, the magnetic flux lines generated around the outer periphery of the magnetic unit 120 can cause a so-called “leak of the magnetic force”, that may affect on the surroundings of the sound generating apparatus 100.

The present invention has been attained by considering the above-mentioned problems. Namely, it is an object of the present invention to provide a sound generating apparatus from which sound with an increased volume can be produced from the sound generating member, by all the magnetic force from a magnet effectively used.

### Means to Solve the Problems

The object of the invention was achieved by a sound generating apparatus according to Claim 1, comprising: a vibration unit including a core member and a solenoid coil wound around the core member, the core member being configured to be attached to a sound generating member, the solenoid coil having a first lateral face, a second lateral face, and a connecting terminal; and a drive unit including: a magnet provided at one end, with respect to the axial direction, of the core member, the magnet having an opposing surface and a fixing surface, the opposing surface opposing the first lateral face of the solenoid coil, the magnet being spaced apart from the first lateral face of the solenoid coil, and a first yoke having a bottom part, a trunk part, and a top part, the bottom part contacting the fixing surface of the magnet, and extending so as to have an outer periphery of the bottom part exceeding the outer periphery of the magnet, the bottom part being extended in a perpendicular direction with respect to the axial direction of the core part, the trunk part being in the form of a cylinder, extending from the bottom part so that the trunk part has a cylindrical inner surface and a cylindrical outer surface, the cylindrical inner surface opposes the outer peripheries of both the magnet and the solenoid coil, the cylindrical inner surface being spaced apart from the outer peripheries of the magnet and the solenoid coil, the top part extending from the trunk part so as to oppose the second lateral face of the solenoid coil, wherein the core member is attached to the sound generating member, the connecting terminal of the solenoid coil being connected to an output terminal of a sonic apparatus, vibration of the solenoid coil being produced by inputting electrical signals from the connecting terminal, the electrical signals provided from the output terminal, the vibration of the solenoid coil being transferred to the sound generating member via the core member, and the sound being generated from the sound generating member.

According to Claim 2, the generating apparatus as claimed in Claim 1 further comprises a second yoke on the opposing surface of the magnet, the second yoke also opposing the first lateral face of the solenoid coil, the second yoke being spaced apart from the lateral face of the solenoid coil.

According to Claim 3, the core member is non-magnetic in the sound generating apparatus as claimed in Claim 1 or 2.

According to Claim 4, the core member is as a thin cylindrical member in the sound generating apparatus as claimed in any of Claims 1 to 3.

According to Claim 5, the vibration unit includes a vibration transmitting member including a stay (connecting rod) and an attachment, the stay penetrating the top part and extending from the core member in the axial direction of the core member, and the attachment extending from the stay in a perpendicular direction with respect to the axial direction of the stay, and contacting the sound generating member, in the sound generating apparatus as claimed in any of Claims 1 to 4.

According to Claim 6, the vibration unit includes a holding member for holding the sound generating member including a supporting hole and a hole-closing bottom, the supporting hole penetrating the top part and extending in the axial direction of the core member, and the hole-closing bottom closing an end of the supporting hole to provide a water-tight closure, in the sound generating apparatus as claimed in any of Claims 1 to 4.

According to Claim 7, the holding member is integral with the core member in the vibration unit, in the sound generating apparatus as claimed in Claim 6.

According to Claim 8, the holding member is detachably provided on the core member in the sound generation apparatus as claimed in Claim 6.

According to Claim 9, the sound generation apparatus as claimed in any of Claims 6 to 8 further comprises a cover member for covering an outer circumference of the holding member, the cover member extending from the top part in an axial direction of the core member, and a predetermined space is provided between the holding member and the cover member.

### EFFECT OF THE INVENTION

In accordance with Claim 1, it is possible to vibrate the solenoid coil in a perpendicular direction with respect to the axial direction of the core member, in response to the electrical signals from a sonic apparatus such as a tape player. Then, the magnetic flux lines extend through a single route coming out of the magnet, passing through a solenoid coil, a top part, trunk part and bottom part of a first yoke, and return back to the magnet. In other words, it is possible to converge the magnetic force of the magnet into the solenoid coil. Therefore, it is possible for the solenoid coil to produce large vibrations. Moreover, it is possible to prevent the magnetic force from leaking to the outside of the sound generating apparatus, and to minimize the effect of the leaked magnetic force to the surroundings of the sound generating apparatus.

Further, it is possible to increase the size of the solenoid coil in a perpendicular direction with respect to the axial direction of the coil member, and to increase the surface area of the solenoid coil, because the magnet is arranged so as to oppose one lateral face of the solenoid coil. When heat is generated by the solenoid coil after the input of electrical signals, it is possible to radiate a large quantity of heat from the solenoid coil due to the large surface area. Moreover, it is possible to eliminate the temperature increase of the solenoid coil itself and the effects of heat to the sound generating member and the surroundings of the sound generating apparatus. Accordingly, it is possible to prevent a plant or tree from withering, when a plant or tree is used as the sound generating member.

According to Claim 2, the provision of the second yoke makes it possible to prevent the magnetic flax lines from diffusing, and to increase the convergence degree of the magnetic force to the solenoid coil. Therefore, it is possible to produce sound with a lager volume as compared to the prior art apparatus, based on electrical signals having the same output.

According to Claim 3, the core member is made of a non-magnetic material, and the solenoid coil 13 is wound to the non-magnetic core member. The solenoid coil is supported by the non-magnetic core member so that the solenoid coil can freely vibrate without any effect of magnetic force.

Therefore, the core member can vibrate to a large extent, and high volume sound is generated from the sound generating member. In this case, it is also possible to reduce inductance, so that frequency characteristics in the high frequency region can be improved, and a high frequency sound can be produced at a high volume.

According to Claim 4, the core member is configured as a thin cylindrical member. Therefore, the core member can vibrate in directions of increasing and decreasing the diameter, in response to the vibration of the solenoid coil. When the sound generating member is attached in an axial direction of the core member, it is possible that the sound generating member vibrates in a perpendicular direction with respect to the axial direction of the core member. Accordingly, a large quantity of sound can be produced from the sound generating member.

A specific embodiment of the present invention is described in Claim 5 as to a vibration unit, wherein the vibration unit includes a vibration transmitting member including a stay, which penetrates the top part of the yoke and extends in the axial direction of the core member, and an attachment, which extends from the stay in a perpendicular direction with respect to the axial direction of the stay.

The attachment, for instance, is attached to a plant as the sound generating member. Then, the vibration of the solenoid coil can be transferred from the core member to the plant, via the stay and the attachment, so that it is possible to obtain sound from the plant.

More specifically, for instance, it is possible that the sound generating apparatus is placed in a flowerpot in a state that the stay protrudes in an upper direction from the vibration unit. Subsequently, a plant is placed on the sound generating apparatus, and the root of the plant is brought into contact with the attachment. Thereafter, the soil is added to the flowerpot. In this state, electrical signals from a sonic apparatus are input to the solenoid coil. Then, the vibration generated on the solenoid coil is transferred to the root of the plant, via the core member the stay and the attachment. The vibration of the root is further transferred to the entire parts of the plant including a stem, trunk, and leaves, so that sound generates from every parts of the plant.

It is also possible to bind a top (free end) of the stay to the stem or the trunk, for transferring the vibration of the solenoid coil from the stay directly to the plant, for generating an increased amount of sound from the plant.

According to Claim 6, it is possible to store water in the supporting hole in the holding member for holding the sound generating member. By inserting the plant as the sound generating member to the supporting hole, and storing water therein, electrical signals from the sonic apparatus is input to the solenoid coil. Thus, a sound is generated from the plant, with giving water to the plant.

A specific embodiment of the holding member for holding the sound generating member is described in Claim 7, wherein the holding member is integral with the core member. Therefore, it is possible to cause the holding member to vibrate with the core member, so that the efficiency of transferring vibration to the sound generating member is increased. In this way, it is possible to increase the volume of sound generated from the sound generating member.

Another specific embodiment of the holding member for holding the sound generating member is described in Claim 8, wherein the holding member is detachable from the core member. According to this embodiment, it is easy to change water stored in the supporting hole with fresh water, or to clean out the holding member.

According to Claim 9, a cover member covers an outer circumference of the holding member, with a predetermined space being provided therebetween. Therefore, the sound of the vibration from the vibration member itself can be absorbed and muted in the space.

The apparatus of the invention surprises and impresses people, because the apparatus is soundless when the holding member does not hold the sound generating member, and generates sound right after the holding member supports the sound generating member.

### DETAILED DESCRIPTION OF THE INVENTION

### First Embodiment

First embodiment of the present invention will now be explained by referring to FIGS. 1 to 3. FIG. 1 is a diagram for explaining a structure of a sound generating apparatus 10 as a first embodiment of the invention. FIG. 2 is an exploded diagram of the sound generating apparatus 10, and FIG. 3 is a diagram for explaining the sound generating apparatus 10 in operation.

The sound generating apparatus causes sound to generate from the entire parts of a tree 1, by being attached to the stem of the tree planted on the ground, as shown in FIG. 3. Here, the sound generating member is not restricted to the tree 1. It is possible to use any material as a sound generating member, as long as the material is rigid sufficiently to transfer vibrations. Specific examples of the sound generating member include a desk, glass, wall and building.

As shown in FIGS. 1 and 2, the sound generating unit includes a vibration unit 11 having a vibration member 12 and a solenoid coil 13, and a drive unit 14 having a magnet 11, and yokes 16 and 17.

The vibration member 12 of the vibration unit 11 is composed of a core member 12c around which a solenoid coil 13 is wound, a planer attachment 12a to be attached to the plant, and a stay 12b for connecting the core member 12c with the attachment 12a. All of these members are made of non-magnetic materials which are rigid and easy to transfer vibrations.

The core member 12c is made of a hollow column-shaped member with a small thickness. A stay 12b is protruded on a surface of the core member 12c so as to be coaxial with the core member 12c, and an attachment 12a is connected to a free end of the stay 12b so that the attachment 12a extends in a perpendicular direction with respect to the axial direction of the stay 12b. Thus, these members are assembled into the vibration unit 11, wherein the members vibrates as a whole.

On both sides of the attachment 12a, insertion opening (not shown) are perforated for receiving a fastening member such as a string therein, and the attachment is fastened to the tree 1 via the fastening member (refer to FIG. 3). The fastening of the attachment 12a to the tree 1 may be carried out not only by the fastening member such as a string, but also by an adhesive, double-sided tape, nail, screw or the like.

The solenoid coil 13 of the vibration unit 11 is configured by providing predetermined windings of a wire material such as copper wire, around the outer periphery of the core member 12c. A pair of connecting terminals 13a and 13b is extended from the wound part of the solenoid coil 13.

The external surfaces of the core member 12c, the stay 12b and the solenoid coil 13 are coated with a coating material (not shown), for instance, a synthetic resin material such as a silicone sealant, so that the core member 12c, stay 12b and solenoid coil 13 are integral with each other. The coating material plays a role as a buffer for avoiding vibration transfer from these members to the vibration unit 14.

The magnet 15 in the drive unit 14 is in the form of a disk having an outer diameter which is almost equal to the outer diameter of the solenoid coil 13. The magnet 15 is coaxially provided on the solenoid coil 13 and the core member 12c. In the present invention, the surfaces of the magnet 15 are called opposing surface 15a and a fixing surface 15b. The opposing surface 15b which corresponds to the north pole (N pole) of the magnet 15 opposes the core member 12c, and the fixing surface 15b which corresponds to the south pole (S pole) faces away from the core member 12c. Herein, the magnet 15 is so placed that an outer part of the opposing surface 15a opposes a first lateral face of the solenoid coil 13a with maintaining a predetermined space therebetween.

The yokes 16 and 17 in the drive unit 14 are made of magnetic materials such as soft iron. The yoke (second yoke) 16 is in the form of a disk having a predetermined thickness and the same diameter with the magnet 15. One surface of the yoke 16 contacts the opposing surface 15a of the magnet 15 in a coaxial arrangement. The outer part on the other surface of the yoke 16, that is a ring-shaped area protruding in an axial direction, opposes the first lateral face of the solenoid coil 13a with maintaining a predetermined space therebetween. A buffer member 19 is interposed between the yoke 16 and the core member 12c, and these are connected among each other. The yoke 16 prevents diffusion of the magnetic flux lines, and helps to increase the convergence degree of the magnetic force of the magnet 16 to the solenoid coil 13. Thus, it is possible in the sound generating apparatus in the present invention to reproduce a high volume sound with an increased volume, as compared with the prior art apparatus, by outputting the electrical signals with the identical output level to the apparatus of the invention and the prior art apparatus.

The yoke (first yoke) 17 contains therein the core member 12c, solenoid coil 13, magnet 15 and yoke 16, and is composed of a trunk part 17a in the form of a cylinder having an inner surface which opposes the magnet and the solenoid coil and which is spaced apart therefrom; a bottom part 17b which closes one end of the trunk part 17a; and a top part 17c which closes another end of the trunk part 17a.

The bottom part 17b is in the form of circular plate extending in a perpendicular direction with respect to the axial direction. The magnet 15 is stationary fixed on an inner surface of the bottom part 17b at the center thereof.

The top part 17c has an opening which the stay 12b of the vibration unit 11 can pass through. The inner diameter of top part 17c is determined to have a size sufficient to receive the stay 12b, with maintaining a predetermined space around the outer circumference of the stay 12b.

On an inner surface of the top part 17c, a protrusion 17d is provided which protrudes in a direction of the solenoid coil 13. The protrusion 17d having a buffer 18 is in contact with the core member 12 so that the buffer 18 is interposed between the protrusion 17d and the core member 12c. The outer part on the surface of the protrusion 17d opposes a second lateral face of the solenoid coil 13, having a predetermined space therebetween.

In the figures, the reference numerals 18 and 19 denote buffers. The buffer 18 is interposed between the protrusion 17d of the yoke 17 and the core member 12c, and the buffer 18 is interposed between the yoke 16 and the core member 12c of the vibration member 12. The buffers 18 and 19 support the core member 12, with permitting the core member 12c to vibrate within the yoke 17.

The fabrication of the sound generating apparatus 10 with the above-mentioned structure is shown in FIG. 2. Namely, in the state where the top part 17c of the yoke is removed, the magnet 15, yoke 16, and buffer 19 are successively placed within the trunk part 17a, with these members being arranged to be coaxial with each other. Then, the core member 12c is placed on the buffer 19, in such a state that the solenoid coil 13 is fit around the core member 12c having a stay 12b on the core member 12c.

Thereafter, the top part 17c is brought close to an open end of the trunk part 17a. The top part 17c is attached to the trunk part 17a by inserting the stay 12b into the opening of the top part 17c, with the buffer 18 interposed between the top part 17c and the trunk part 17a.

In accordance with the above-mentioned fabrication, the magnet 15 is placed between the yoke 16 and the bottom part 17b of the yoke 17 within the trunk part 17a, and the vibration member 12 is supported between the yoke 16 and the protrusion 17d of the yoke 17, so that the core member 12c is interposed between the buffers 18 and 19 inside of the trunk part 17a. Accordingly, the yoke 16 and the protrusion 17d of the yoke 17 oppose the first lateral face of the solenoid coil 13 and the second lateral face thereof, respectively.

As a result, the magnetic flux lines of the magnet 15 extend through a single route, as shown by the dotted line with arrows in FIG. 1. In other words, the magnetic flux lines extend from the N pole, which corresponds the opposing surface 15b of the magnet 15, to the upper direction, and comes into a protruded ring-shaped part of the solenoid coil 13, that is above the yoke 16. After passing through the solenoid coil 13, the magnetic flux lines enter into the top part 17c of the yoke 17 from the protrusion 17d. Then, magnetic flux lines pass through the top part 17c, go down through the trunk part 17a and the bottom part 17b, and finally enter into the S pole, which corresponds to the lower surface of the magnet 15. According to the present invention, no magnetic force leaks from the magnet 15 or the yokes 16 and 17. To the contrary, the entire magnetic force of the magnet 15 can be applied to the solenoid coil 13, differently from the prior art technology.

A tree 1 is attached to the thus described sound generating apparatus 10. The connecting terminal 13a is connected to an output terminal of a tape payer (sonic apparatus) which is not shown, to provide a “ready” state. In this state, electrical signals, for instance, music is output from the output terminals of the tape player. The electrical signals are input to the connecting terminal 13a, and magnetic force is obtained through the solenoid coil 13. The magnetic force generated from the solenoid coil 13 cooperates with the magnetic force of the magnet 15. Accordingly, the solenoid coil 13 vibrates in response to the electrical signals. The vibration is transferred from the vibration member 12 to the tree, and sound such as music comes out of the tree 1.

According to the sound generating apparatus 10 of the first embodiment, it is possible to achieve a large vibration of the solenoid coil 13 because it is possible to converge the magnetic force of the magnet to the solenoid coil 13. Moreover, it is possible to eliminate leakage of magnetic force from the sound generating apparatus 10 to the outside thereof, and hence to avoid effects of the leaked magnetic force to the surroundings of the sound generating apparatus 10. This is because the magnet 15 is present between the yoke 16 and the bottom 17b of the yoke 17 to provide an arrangement wherein the first and the second lateral faces of the solenoid coil 13 respectively oppose the yoke 16 and the top part 17c of the yoke 17.

Furthermore, it is possible to prevent the magnetic force leakage from the sound generating apparatus 10 to the outside thereof, and to eliminate effect of the leaked magnetic force to the environment around the sound generating apparatus 10.

Furthermore, it is possible to enlarge the spooling diameter of the coil in a perpendicular direction with respect to the axial direction of the core member because the magnet 15 is configured to face the first lateral face of the solenoid coil, in comparison with the case. This is different from prior art shown, for instance, in FIG. 10, where the solenoid coil 112 is placed within the inner diameter 122 of the magnet 122.

Therefore, it is possible to obtain a large surface area of the solenoid coil 13 according to the present invention, and hence to obtain a large quantity of radiation of heat from the solenoid coil 13, the heat being generated in the solenoid coil 13 by the input of the electrical signals. Accordingly, it is possible to minimize the temperature increase of the solenoid coil 13, and the effect of the heat to the environment around the sound generating apparatus 10 such as the tree 1.

In the above-mentioned sound generating apparatus 10, the core member 12c, around which the solenoid coil is provided, is prepared from a non-magnetic material. Accordingly, the core member 12c is not affected by the magnetic force of the magnet 15, and supports the solenoid coil 13 with permitting the solenoid coil 13 freely vibrate. This contributes to increase the volume of the sound generated from the tree 1, because the vibration member 12 in the vibration unit 11 largely vibrates. It is also possible to decrease the inductance, because the core member 12c of the vibration member 12 is non-magnetic. Consequently, frequency characteristics in the high frequency region are improved, and sound with a high frequency can be produced with an increased volume.

### Second Embodiment

A sound generating apparatus 20 as a second embodiment is a modified example of the sound generating apparatus 10 described in the first embodiment. The sound generating apparatus 20 is for generating sound from a tree 2 planted in the flowerpot 3.

FIG. 4 is a diagram for explaining the sound generating apparatus 20 in the second embodiment. The detailed explanation is partially omitted by applying the same symbols to the elements/members that are identical with those in the first embodiment.

The sound generating apparatus 20, as shown in FIG. 4, is contained in the internal part of the flowerpot 3. The flowerpot 3 is filled with soil to a predetermined height, and a plant 2 such as foliage plant is planted therein, as an example of the sound generating member. In the sound generating apparatus 20 is placed in the soil almost at a base part of the flowerpot 3, with the stay 12d protruded from the core member 12 in an upper direction thereof.

The base part of the stay 12d is fixed to the center part of the core member 12c. The stay 12d extends in an axial direction of the core member 12c, and the free end of the stay 12d protrudes from the surface of the soil 3a in the flowerpot 3 by passing through the opening of the top part 17c. The stay 12c has a predetermined length and is attached to the plant along the stem or trunk 2a of the plant 2. The protruded part of the stay 12d is bound to the stem or trunk 2a by a binding member P in the form of a strand. Based on this structure, vibration of the stay 12d can be transmitted from the stem or trunk 2a to the entire parts of the plant 2.

A vibration transmitting plate 12e is provided approximately at the center of the stay 12d. The vibration transmitting plate 12e is in the form of a disk extending in a perpendicular direction with respect to the axial direction of the stay 12d. The vibration transmitting member 12e is fixed to the stay 12 by using a check nut, so as to be coaxial with the stay 12d. A net member 12f, which is in the form of a cylinder, is provided on the vibration transmitting plate 12e. The net member 12f is attached around an outer periphery of the vibration transmitting plate 12e and the cylindrical body extends in an upper direction. The vibration transmitting plate 12e and the net member 12f (attachment) are rigid members made of stain-less steel or plastic materials, for making it possible to transfer the vibration of the stay 12d, when vibration transmitting plate 12e and the net member 12f are in contact with a root 2b of the plant 2 in the soil.

A sealing treatment is applied (not shown) to a connecting part between the top part 17c of the yoke 17 and the trunk part 17a, and a space formed between the opening of the top part 17c and the stay 12d penetrating the opening, for preventing external things such as water or soil from entering into the inside of the yoke 17.

After the connecting terminal 13c of the sound generating apparatus 20 is connected to the output terminals of the tape player (sonic apparatus), a “ready” state is attained. Then, electrical signals such as music are output from the output terminals of the tape player. The electrical signals are input to the connecting terminal 13a, so that a magnetic force is generated from the solenoid coil 13. By the cooperation of the magnetic force generated by the solenoid coil 13 with that from the magnet 15, vibrations are generated on the solenoid coil 13 depending on the electrical signals. Thereafter, the vibrations are transmitted to the stay 12d, vibration transmitting plate 12e, net member 12f and the plant 2. Thus, sound such as music is reproduced from the plant 2.

In addition to the function and effect of the sound generating apparatus 10 of the first embodiment, the sound generating apparatus 20 of the second embodiment is used for generating a large quantity of sound from the plant 2, by transmitting vibration of the vibrating member 12 to the stem or trunk 2a, and the root 2b of the plant 2.

It is possible that the yoke 16, which is provided between the magnet 15 and the solenoid coil 13 in the first and the second embodiments, is omitted.

### Third Embodiment

FIG. 5 is a diagram for explaining a structure of a sound generating apparatus 30 according to a third embodiment of the present invention. FIG. 6 is an exploded diagram of the sound generating apparatus 30, and FIG. 7 is a diagram for explaining the sound generating apparatus 30 in operation.

The sound generating apparatus 30 in the third embodiment, as shown in FIG. 7, is a so-called flower-vase type. It is possible to arrange a flower 4, that is an example of the sound generating member, directly in the sound generating apparatus 30, and sound generates directly from the flower 4. FIGS. 5 and 6 show that the sound generating apparatus 30 includes a vibration unit 31 composed of a vibration member 32 and a solenoid coil 33; and a drive unit 34 composed of a magnet 35 and yokes 36 and 37.

The vibration member of the vibration unit 31 includes the core member 32a on which the solenoid coil 33 is wound. The core member 32a is in the form of a thin cylinder, which is, for example, made of a non-magnetic material such as bamboo, aluminum, brass, or Bakelite materials. A core member 32a extends in an axial direction thereof by penetrating a top part 37c of a yoke 37. Furthermore, a holding member 39 for holding the sound generating member 30 includes a supporting hole 39a and a hole-closing bottom 39b, and formed integrally with the core member 32a. The supporting hole 39a has a size sufficient to receive and hold the flower 4, and the bottom 39b is provided on an end of the supporting hole 39a to provide a water-tight closure.

The core member 32a is supported by the drive unit 34 by extending in a vertical direction in a state that the flower 4 can be inserted in the supporting hole 39a of the holding member 39 and that a predetermined amount of water can be stored therein.

The solenoid coil 33 of the drive unit 31 is formed by winding a wire material such as copper wire around the outer periphery of the core member 32a, and ends of the wire material are extended from the wound part of the coil, as a pair of connecting terminals 33a.

The core member 32a and the solenoid coil 33 are made integral with each other, by application of coating materials to the surface of the member 32a and the coil 33. Examples of the coating material are synthetic resin materials such as a silicone sealant. The coating material plays a role as a buffer for restricting the transmission of vibration from the vibration unit 31 to the drive unit 34, when the vibration unit 31 such as the core member 32a and the solenoid coil 33 are in contact with the drive unit 34.

A magnet 35 in the drive unit 34 is in the form of a disk having a predetermined thickness, and is provided so as to oppose the bottom part of the core member 32a. The diameter of the magnet 35 is so determined that the outer part of an upper surface 35a opposes a lower surface (first lateral face) of the solenoid coil 33. The magnet 35 is fixed on a bottom part 37b of a yoke 37, having the N pole on the upper surface 35a and the S pole on the lower surface 35b.

The yokes 36 and 37 in the drive unit 37 are prepared by a non-magnetic material such as soft iron. The yoke (second yoke) 36 is in the form of a disk having a predetermined thickness and the same diameter with the magnet 35. One surface of the yoke 36 contacts the opposing surface 35a of the magnet 35 in a coaxial arrangement. The outer part on the other surface of the yoke 36, that is a ring-shaped area protruding in an axial direction, opposes the first lateral face of the solenoid coil 33 with maintaining a predetermined space therebetween. A buffer member 38 is interposed between the yoke 36 and the core member 32a, and these are connected among each other.

The yoke (first yoke) 37 contains therein a lower part of the core member 32a, solenoid coil 33, magnet 35 and yoke 36. The yoke 37 is composed of a trunk part 37a in the form of a cylinder having an inner surface which opposes outer peripheries of the solenoid coil 33 and the magnet 35 and which is spaced apart therefrom; a bottom part 37b which closes one end of the trunk part 37a; and a top part 37c which closes another end of the trunk part 37a.

The bottom part 37b is in the form of a planer disk with the plane extending perpendicularly with respect to the axial direction of the sound generating apparatus. The magnet 35 is stationary fixed on an inner surface of the bottom part 37b at the center thereof. The top part 37c has a circular opening which the lower part of the core member 32a can pass through. The inner diameter of the top part 17c is determined to have a size sufficient to receive the core member 32a, with maintaining a predetermined space between the inner diameter of the top part 37c and the outer circumference of the core member 32a.

On an inner surface of the top part 37c, a protrusion 37d is provided which protrudes in a direction of the solenoid coil 33. The protrusion 37d is in the form of a ring corresponding to a periphery of the opening, and the free end of the protrusion 37d opposes the upper side of the solenoid coil 33, having a predetermined space therebetween.

Moreover, a cover member V is provided on an upper surface of the top part 37c. The cover member V is made of a material having a resistance to water, such as a metal, plastic, or china. The cover member V is in a cylindrical shape, and surrounds an outer circumference of the holding member while maintaining a predetermined space therebetween. The cover member V extends in an upper direction, exceeding the top end of the core member 32a. The bottom end of the cover member V is in a close contact with the upper surface of the top part 37c, and fixed thereto by an adhesive or the like.

A sealant U such as a silicone sealant is applied to a portion between the inner periphery of the cover member V and the upper part of the core member 32a, for sealing the portion. Accordingly, water does not penetrate into the space defined by the cover member V and the core member 32a when water is poured in the core member 32a exceeding the top part of the core member 32a.

In the figures, the reference numeral 38 denotes a buffer. The buffer 38 is interposed between the yoke 36 and the core member 32a. The buffer 38 supports the core member 32a on the yoke 36, with permitting the core member 32a to vibrate.

The fabrication of the sound generating apparatus 30 with the above-mentioned structure is shown in FIG. 6. Namely, in the state where the top part 37c of the yoke 37 is removed, the magnet 35, yoke 36, and buffer 38 are successively placed within the trunk part 37a, with these members being arranged to be coaxial with each other. Then, the core member 32a is placed on the buffer 38, in such a state that the solenoid coil 33 is placed on the core member 32a. The solenoid coil 33 is arranged to have the outer part thereof opposed to the inner periphery of the trunk part 37a.

Thereafter, the core member 32a is inserted in the opening of the top part 37c. After being brought close to the trunk part 37a, the top part 37c is attached to one end of the trunk part 37a. The cover member V is also adhesively fixed on the upper surface of the top part 37c. The fabrication is completed by sealing the portion between the inner periphery of the cover member V and the upper part of the core member 32a, which is contained in the cover member V, by using a sealant U.

In accordance with the above-mentioned fabrication, the magnet 35 is placed between the yoke 36 and the bottom part 37b of the yoke 37, within the trunk part 37a. The core member 32a is placed on the yoke 36, so that the bottom part 39b of the holding member 39 is installed on the yoke 36 in the trunk part 37a. Therein, the buffer 38 is interposed between the bottom part 37b and the yoke 36. Accordingly, the yoke 36 and the protrusion 37d of the yoke 37 oppose the lower lateral face of the solenoid coil 33 and the upper lateral face thereof, respectively.

As a result, the magnetic flux lines of the magnet 35 extend through a single route, as shown by the dotted line with arrows in FIG. 5. In other words, the magnetic flux lines extend from the N pole, which corresponds the upper surface of the magnet 35, to the upper direction, and comes into the yoke 36 and then solenoid coil 33 from the lower surface thereof. After passing through the solenoid coil 33, the magnetic flux lines enter into the top part 37c of the yoke 37 from the protrusion 37d. Then, magnetic flux lines pass through the top part 37c, go down through the trunk part 37a and reach the bottom part 37b. Finally, the flux lines enter into the S pole that corresponds to the lower surface of the magnet 35.

According to the present invention, no magnetic force leaks from the magnet 35 or the yokes 36 and 37. To the contrary, the entire magnetic force of the magnet 35 can be applied to the solenoid coil 33, differently from the prior art technology.

As shown in FIG. 7, the sound generating apparatus 30 with the above-mentioned structure is placed on a table or a shelf. The flower 4 can be inserted in the supporting hole 39a of the holding member 39 and the connection terminals 33a are connected to output terminals of a tape player (sonic apparatus) (not shown), to initiate a “ready” state.

Then, electrical signals such as music are output from the output terminals of the tape player, and input to the connecting terminal 33a, so that a magnetic force is generated from the solenoid coil 33. By the cooperation of the magnetic force generated by the solenoid coil 33 with that from the magnet 35, vibrations are generated on the solenoid coil 33, depending on the electrical signals. Thereafter, the vibrations are transmitted from the core member 32a to the flower 4. Thus, sound such as music is reproduced from the flower 4.

According to the sound generating apparatus 30 of the third embodiment, it is possible to achieve a large vibration of the solenoid coil 33 because it is possible to converge the magnetic force of the magnet 35 to the solenoid coil 33. Moreover, it is possible to eliminate leakage of magnetic force from the sound generating apparatus 30 to the outside thereof, and hence to avoid effects of the leaked magnetic force to the surroundings of the sound generating apparatus 30. This is because the magnet 35 is provided between the yoke 36 and the bottom part 37b of the yoke 37 to provide an arrangement wherein the lower and the upper lateral faces of the solenoid coil 33 respectively oppose the yoke 36 and the top part 37c of the yoke 37. In this configuration, the magnetic flux lines of the magnet 35 extend through a single route, that extend from the upper surface of the magnet 35 to the lower surface thereof, passing through the yoke 36, solenoid coil 33, top part 37c of the yoke 37, trunk part 37a, and bottom part 37b of the yoke 37.

Furthermore, it is possible, in the third embodiment, to positively converge the magnetic force on the solenoid coil 33 by the provision of the ring-shaped protruded part of the yoke 36 and the protrusion 37d of the top part 37c. By this configuration, the ring shaped protruded part of the yoke 36 and the protrusion 37 opposes the lower surface of the solenoid coil 33 and the upper surface thereof, respectively. Therefore, a it is possible to induce vibrations with a magnitude larger than in the other embodiment.

Moreover, it is possible to enlarge the spooling diameter of the coil 33, as compared, for instance, with prior art technology shown in FIG. 10 wherein the solenoid coil is provided in the hole as an inner diameter of the disk shaped magnet. This is because the coil 33 is placed above the solenoid coil 33, in the present invention. It is also possible to radiate a large quantity of heat from the solenoid coil, due to the large surface area, and to eliminate the temperature increase of the solenoid coil itself and the effects of heat to the flower 4 and the surroundings of the sound generating apparatus 30.

In the sound generating apparatus 30, the core member 39 vibrates in an axial direction thereof, in response to the vibration of the solenoid coil 33 in an axial direction of the trunk part 37a in the yoke 37, after imputing electrical signals from the sonic apparatus. Therefore, the flower 4 vibrates in a horizontal direction, so that music is reproduced from the flower 4 with a high volume.

Moreover, in the sound generating apparatus 30, the core member 32a, around which the solenoid coil 33 is provided, is made of a non-magnetic material. Accordingly, the core member 32a is not affected by the magnetic force of the magnet 35, and supports the solenoid coil 33 with permitting the solenoid coil 33 freely vibrate. This contributes to increase the volume of the sound generated from the flower 4, because of the large vibrations of the vibration unit 31. It is also possible to decrease the inductance, because the core member 12c of the vibration member 12 is non-magnetic. Consequently, frequency characteristics in the high frequency region are improved, and sound with a high frequency can be produced with an increased volume.

Moreover, the holding member 39 for holding the sound generating member is made integral with the core member 32a. Therefore, it is possible to cause the holding member 39 to vibrate together with the core member 32a, so that the efficiency of transferring vibration to the flower 4 supported by the holding member 39 is increased. In this way, it is possible to increase the volume of sound generated from the sound generating member.

Moreover, it is possible to prepare the core member 32a as a thin cylindrical member. Therefore, the core member 32a can vibrate in directions of increasing and decreasing the diameter, in response to the vibration of the solenoid coil 33. Accordingly, the vibration of the core member 32a is transmitted to the flower 4 in the holding member 39 with an increased reliability. Consequently, sound with increased volume is generated from the flower 4.

In addition to the above, the sound leaking from the core member 32a can be absorbed and muted in the space, by covering the outer circumference of the cover member 32a with the cover member V. It is also possible to pour water into the core member 32a to a high level when the sealant is applied to the portion/space between the upper part of the core member 32a and the cover member V. By this configuration, it is possible to completely mute the sound leaked out of the core member 32a. Therefore, the apparatus of the invention surprises and impresses people, because the apparatus is soundless when the holding member does not hold the flower 4, and generates sound right after the holding member 39 supports the sound generating member.

It is possible that the yoke 36, which is provided between the magnet 35 and the solenoid coil 33 in the third embodiment, is omitted.

### Fourth Embodiment

A sound generating apparatus 40 as a fourth embodiment is a modified example of the sound generating apparatus 30 described in the third embodiment. Likewise, a flower 4, that is an example of the sound generating member, can be inserted directly to the sound generating apparatus. The sound generating apparatus 40 is for generating sound at a high volume directly from the flower 4.

FIG. 8 is a diagram for explaining the sound generating apparatus of the fourth embodiment, and FIG. 9 is an exploded diagram of the sound generating apparatus 40. The detailed explanation is partially omitted by applying the same symbols to the elements/members that are identical with those in the first embodiment.

A specific feature of the fourth embodiment is that a holding member 43 for holding the sound generating member is formed separately from the core member 42a, for making the core member 42 detachable.

The sound generating apparatus 40, as shown in FIGS. 8 and 9, includes a vibration unit 41 including a vibration member 42 and a solenoid coil 33, and a driving unit 34 including a magnet 35 and a yoke 36.

The vibration member 42 of the vibration unit 41 includes a core member 42a made of a non magnetic member. The core member 42a is made of a hollow column-shaped member with a small thickness and a predetermined height in an axial direction. The solenoid coil 33 is provided on the outer circumference of the core member 42a.

A holding member 43 for holding the sound generating member is detachably provided on the core member 42a. The holding member 43 is in the form of a thin cylinder, which is, for example, made of a non-magnetic material such as bamboo, aluminum, brass, or Bakelite materials. The holding member 43 extends in an upper direction along the axial direction of the core member 42a, and penetrates the top part 37c of the yoke 37. The holding member 43 includes a supporting hole 43a having a size sufficient to receive and hold the flower 4, and a bottom part 43b for closing the bottom of the supporting hole 43a, to provide a water-tight closure. This structure makes it possible to maintain the holding member 43 in a vertical direction and to store a predetermined amount of water therein, simultaneously.

Furthermore, a magnetic plate 43c is provided on the bottom part 43b of the holding member 43. The magnetic plate 43c is attracted to the magnet 35 due to the magnetic attraction, so that the surface of the bottom part 43b is brought into contact with the upper part of the core member 42a. Due to the magnetic attraction, the holding member 43 for holding the sound generating member is maintained in a vertical direction. Further, the holding member 43 can be detached from the core member 42a, by holding and lifting the holding member 43.

The external surfaces of the core member 42a, the holding member 43 and the solenoid coil 33 are coated with a coating material (not shown), for instance, a synthetic resin material such as a silicone sealant, so that the core member 42a, the holding member 43 and the solenoid coil 33 are integral with each other. The coating material plays a role as a buffer for avoiding vibration transfer from the core member 42a, holding member 43 and solenoid coil 33 to the yokes 36 and 37.

The top part 37c has an opening having a circular shape, when viewed from the above. The opening extends in the axial direction of the top part 37c. The opening is located approximately at the center of the top part 37c and the holding member 43 can pass through the opening. The inner diameter of the top member 37c is sufficient to receive the holding member 43 therein, with maintaining a predetermined space between the top part 37c and the outer circumference of the holding member 43.

Moreover, a cover member V is provided on the top part 37c so as to surround the outer circumference of the holding member 43. The cover member V is in a cylindrical shape, and surrounds an outer circumference of the core member 32a while maintaining a predetermined space therebetween. The cover member V extends in an upper direction, with respect to the apparatus, further than the top end of the core member 32a. The bottom end of the cover member V is fixed to the upper surface of the top part 37c by an adhesive or the like.

Furthermore, a cap W is detachably provided between the inner circumference of the cover member V and an upper part of the holding member 43. The cap W is made of a material which can absorb vibrations, such as silicone. It is possible to prevent water from penetrating into the space defined by the cover member V and the holding member 43 when water is poured in the holding member 43 exceeding the top part of the holding member 43. Namely, sealing effect is obtained by the provision of the cap. It is also possible to detach the holding member 43, for taking the holding member 43 out of the apparatus.

The fabrication of the sound generating apparatus 40 with the above-mentioned structure is shown in FIG. 9. Namely, in the state where the top part 37c of the yoke 37 is removed, the magnet 35, yoke 36, and buffer 38 are successively placed within the trunk part 37a, with these members being arranged to be coaxial with each other.

Then, the core member 42a, to which the solenoid coil 33 is attached, is placed on the magnet 35 via the buffer 38. Then, the holding member 43 for holding the sound generating member is provided on the core member 42c.

Thereafter, the holding member 43 is inserted to the opening of the top part 37c. After being brought close to the trunk part 37a, the top part 37c is attached to an end of the trunk part 37a. The cover member V is also adhesively fixed on the upper surface of the top part 37c. The fabrication is completed by sealing the portion between the upper part of the holding member 43 and the inner periphery of the cover member V, with installing the cap W to the upper part of the apparatus.

The sound generating apparatus 40 with the above-mentioned structure is placed on a table or a shelf. The flower 4 can be inserted in the holding member 43 (refer to FIG. 7) and the connection terminals 33a are connected to output terminals of a tape player (sonic apparatus) (not shown), to initiate a “ready” state.

Then, electrical signals such as music are output from the output terminals of the tape player. The electrical signals are input to the connecting terminal 33a, so that magnetic force is generated from the solenoid coil 33. By the cooperation of the magnetic force generated by the solenoid coil 33 with that from the magnet 35, vibrations are generated on the solenoid coil 33, depending on the electrical signals. Thereafter, the vibrations are transmitted from the holding member 43 to the flower 4. Thus, sound such as music is reproduced from the flower 4.

According to the sound generating apparatus 40 in the fourth embodiment, it is possible to use a detachable holding member, in addition to the function and effect of the sound generating apparatus 30 in the third embodiment. According to this embodiment, it is easy to change water stored in the holding member 43 for holding the sound generating apparatus with fresh water, or to clean out the holding member.

It is possible that the yoke 36, which is provided between the magnet 35 and the solenoid coil 33 in the fourth embodiment, is omitted.

The scope of the present invention is not restricted to the above-mentioned first to fourth embodiments. The present invention may be varied in many ways as long as such variations are not to be regarded as a departure from the scope of the present invention. For instance, the circular shapes of the magnet and the solenoid coil, explained in the above embodiments can be changed into square shapes.

### BRIEF DESCRIPTION OF THE DRAWINGS

FIG. 1 is a diagram for explaining a structure of the sound generating apparatus of a first embodiment.

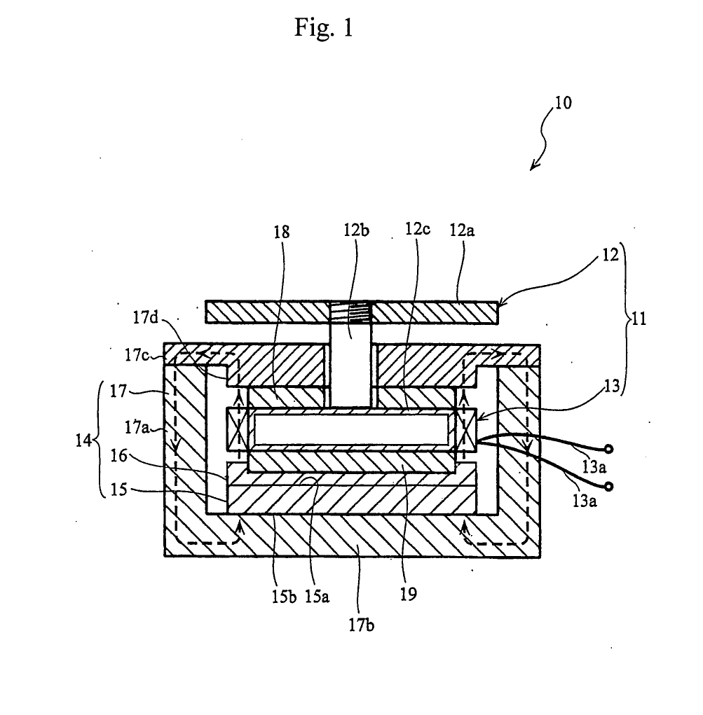

FIG. 2 is an exploded diagram of the sound generating apparatus.

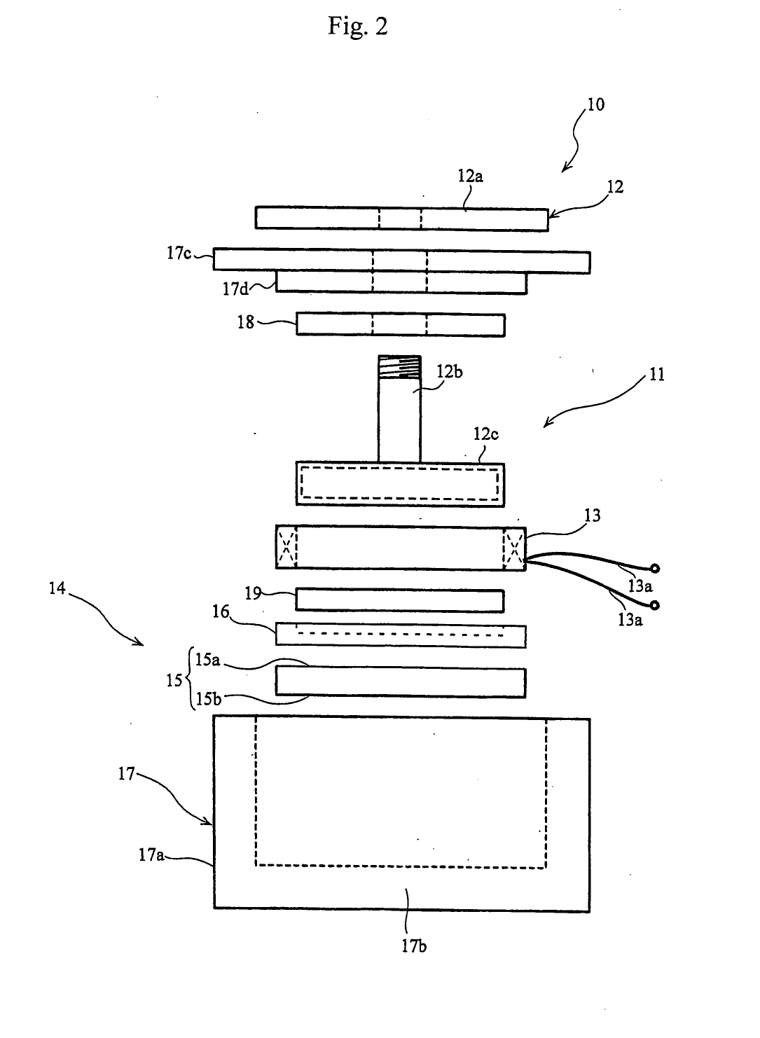

FIG. 3 is diagram for explaining the sound generating apparatus in operation.

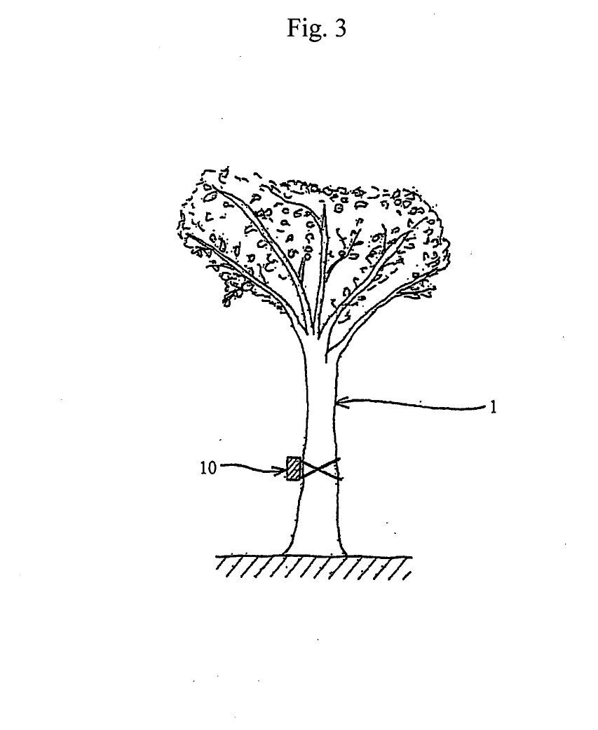

FIG. 4 is a diagram for explaining a structure of the sound generating apparatus of a second embodiment.

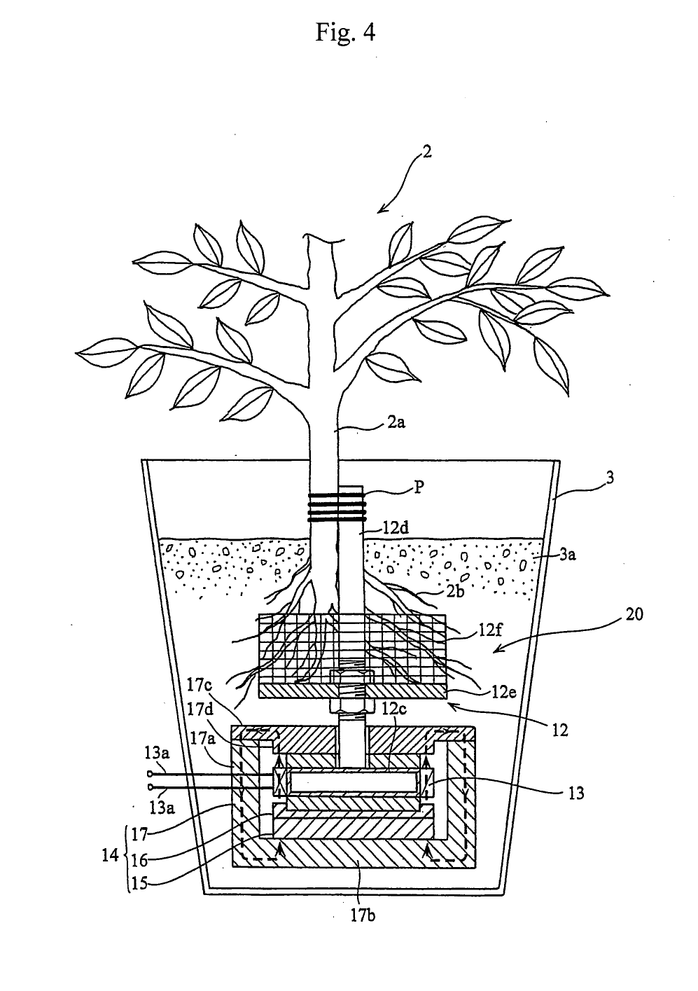

FIG. 5 is a diagram for explaining a structure of the sound generating apparatus of a third embodiment.

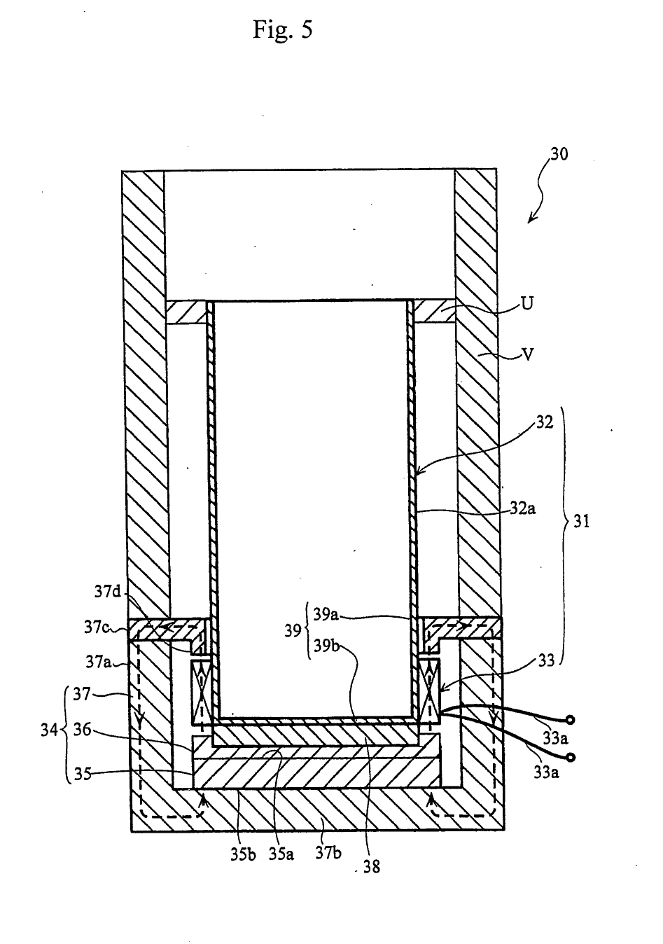

FIG. 6 is an exploded diagram of the sound generating apparatus.

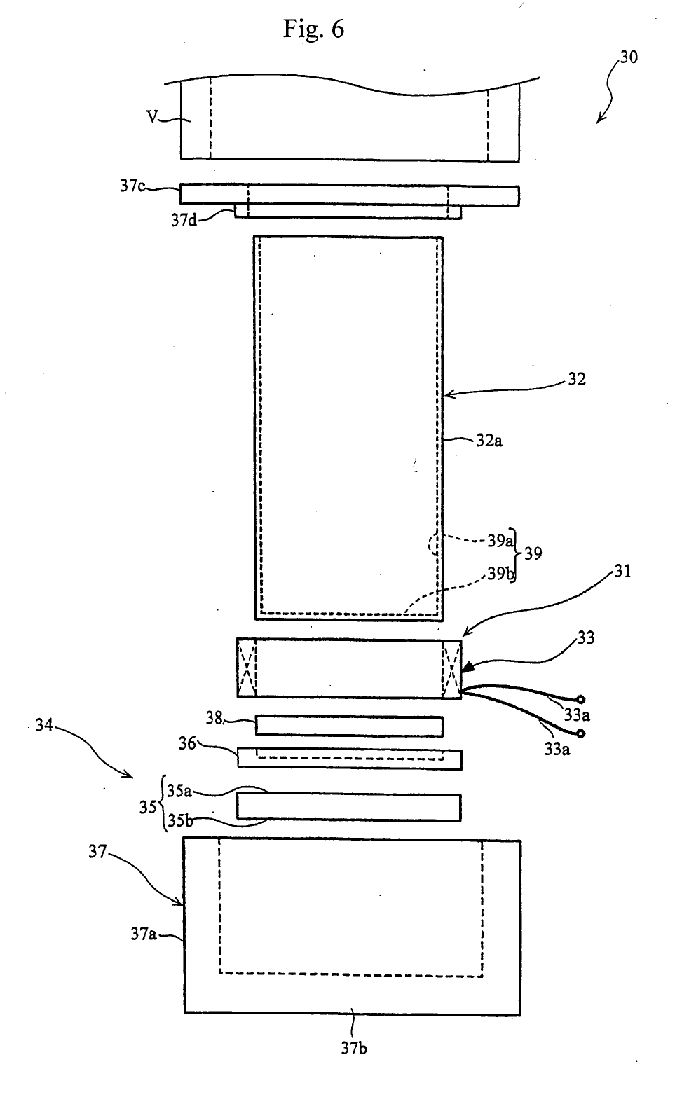

FIG. 7 is diagram for explaining the sound generating apparatus in operation.

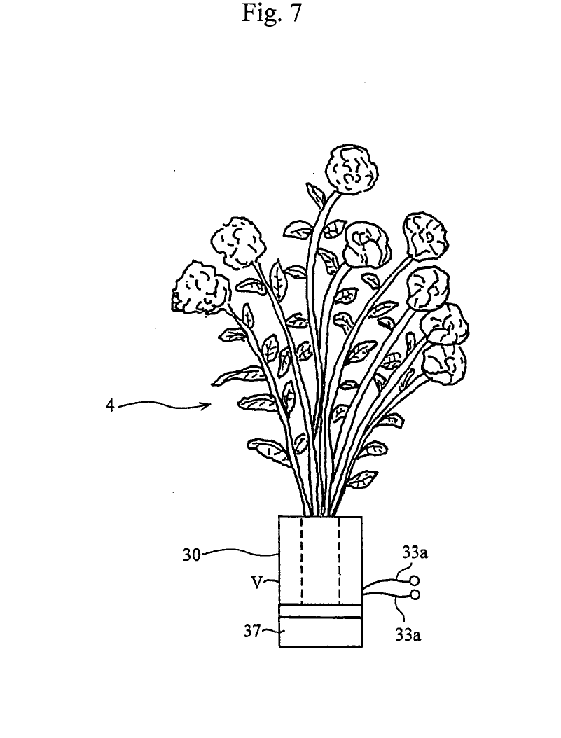

FIG. 8 is a diagram for explaining a structure of the sound generating apparatus of a fourth embodiment.

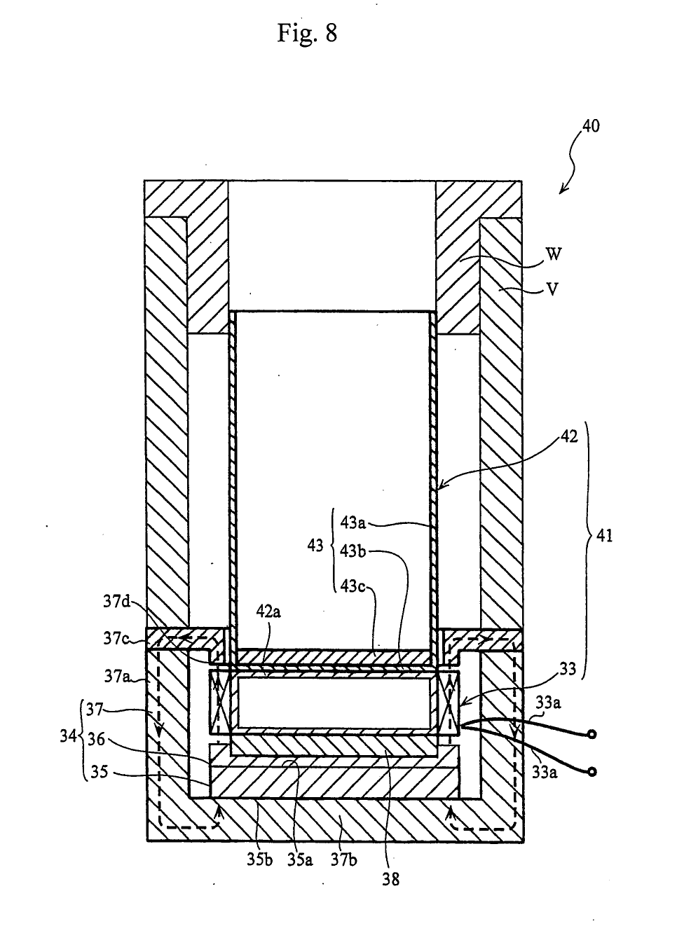

FIG. 9 is an exploded diagram of the sound generating apparatus.

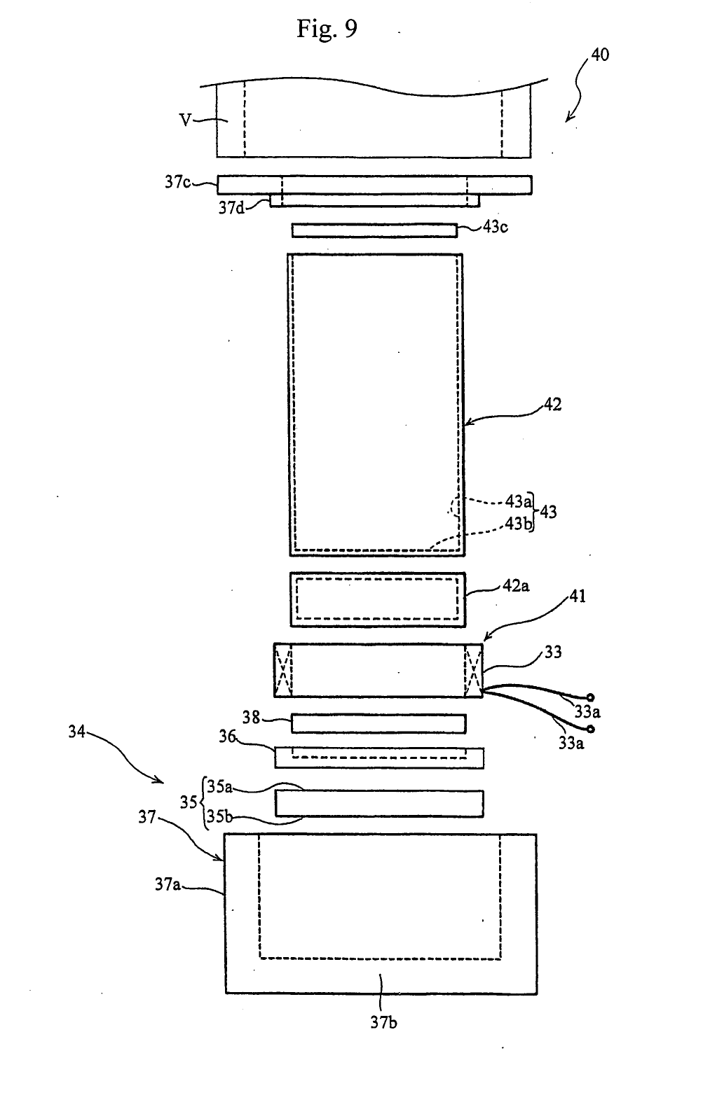

FIG. 10 is diagram for explaining a prior-art sound generating apparatus 100.

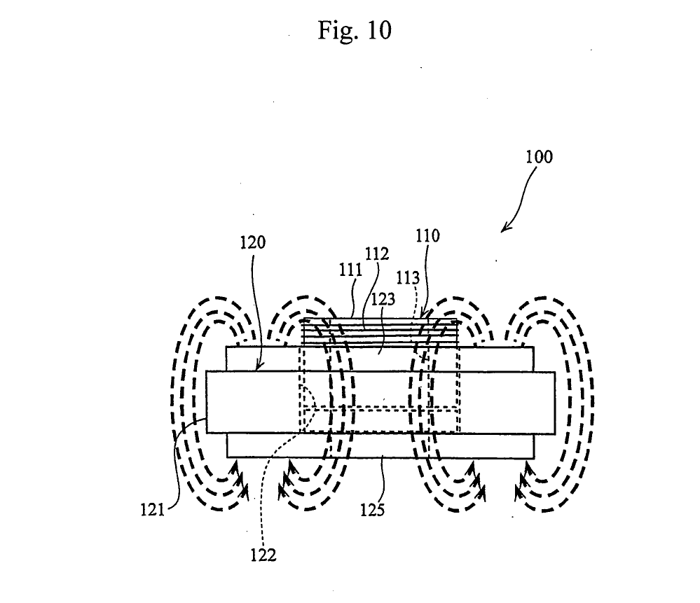

### DESCRIPTION OF REFERENCE NUMERALS

1 Tree
2 Plant
3 Flowerpot
4 Flower
10, 20, 30, 40 Sound generating apparatus
11, 31, 41 Vibration unit
12, 32, 42 Vibrating member
12a Attachment
12b, 12d Stay
12c, 32a, 42a Core member
13, 33 Solenoid coil
14, 34 Drive unit
15, 35 Magnet
16, 36 First yoke
17, 37 Second yoke
18, 19, 38 Buffer
39, 43 Holding member for holding sound generating member
V Cover member

1. A sound generating apparatus, comprising:
a holding member configured to hold a sound generating member,
a core member configured to receive the holding member,
a solenoid coil configured by winding a material around an outer periphery of the core member, with respect to the axial direction thereof,
a magnet provided at one end, with respect to the axial direction, of the core member, an outer part of the magnet, with respect to the axial direction of the core member, extending further than an outer periphery of the core member, the magnet opposing one lateral face of the solenoid coil, and
a first yoke having a trunk part, a bottom part, and a top part, the trunk part being in the form of a cylinder extending in the axial direction of the core member, the trunk part surrounding an outer circumference of the core member, when viewed the axial direction of the core member, the trunk part and the solenoid coil maintaining a predetermined space therebetween, the bottom part provided on one end of the trunk part, and the magnet being provided on the bottom part, the top part being provided on another end of the trunk part, the top part opposing a second lateral face of the solenoid coil,
wherein the core member is attached to the sound generating member, a connecting terminal of the solenoid coil being connected to an output terminal of a sonic apparatus, vibration of the solenoid coil being produced by inputting electrical signals from the connecting terminal, the electrical signals provided from the output terminal, the vibration of the solenoid coil being transferred to the sound generating member via the core member, and the sound being generated from the sound generating member.

2. The sound generating apparatus as claimed in claim 1, further comprising a second yoke provided on the magnet, the second yoke being interposed between the magnet and the first lateral face of the solenoid coil, the second yoke opposing the first lateral face of the solenoid coil, with maintaining a predetermined space therebetween.

3. The sound generating apparatus as claimed in claim 1 or 2, wherein the core member is non-magnetic.

4. The sound generating apparatus as claimed in claim 1, wherein the core member is as a thin cylindrical member.

5. The sound generating apparatus as claimed in claim 1, wherein the holding member for holding the sound generating apparatus includes a vibration transmitting member including a stay and an attachment, the stay penetrating the top part and extending from the core member in the axial direction of the core member, and the attachment extending from the stay in a perpendicular direction with respect to the axial direction of the stay, and contacting the sound generating member.

6. The sound generating apparatus as claimed in claim 1, wherein the holding member for holding the sound generating apparatus is configured by including a cylindrical member, a supporting hole and a hole-closing bottom, the supporting hole penetrating the top part and extending in the axial direction of the core member, the supporting hole receiving and holding the sound generating member, and the hole-closing bottom closing an end of the supporting hole to give a water-tight closure.

7. The sound generating apparatus as claimed in claim 6, wherein the holding member is detachably provided on the core member.

8. The sound generation apparatus as claimed in claim 6, wherein the holding member is integral with the core member.

9. The sound generation apparatus as claimed in claim 6, further comprising a cover member for covering an outer circumference of the holding member, the cover member extending from the top part in an axial direction of the core member, and a predetermined space is provided between the holding member and the cover member.
